(19) United States
(12) Patent Application Publication
(10) Pub. No.: US 2025/0020886 A1
(43) Pub. Date: Jan. 16, 2025

(54) WELDED ARMOR FOR FIBER CABLE

(71) Applicant: CommScope Technologies LLC, Claremont, NC (US)

(72) Inventors: Jason N. Morrow, Taylorsville, NC (US); Eddy R. Houston, Claremont, NC (US)

(21) Appl. No.: 18/769,234

(22) Filed: Jul. 10, 2024

Related U.S. Application Data
(60) Provisional application No. 63/526,446, filed on Jul. 12, 2023.

(51) Int. Cl. G02B 6/44

(52) U.S. Cl. CPC G02B 6/4488; G02B 6/4432; G02B 6/4435

(57) ABSTRACT

A corrugated armoring layer for a communication cable is primarily formed of an elongated strip of metal or alloy, e.g., steel, having a first side and an opposite, second side. The armoring layer is wrapped around a cable core so that first and second side edges come to abut, or slightly overlap, and then are welded either continuously or intermittently to form a seam. In the case of intermittent welding, it is preferred that only the tops or outward-facing ridges of the corrugations are welded, such as every top corrugation or every other top corrugation is welded. A conductive adhesive tape may be applied along the seam as well, if additional environmental sealing and/or electrical shielding is desired.

This application claims the benefit of U.S. Provisional Application No. 63/526,446, filed Jul. 12, 2023, which is herein incorporated by reference.

### BACKGROUND OF THE INVENTION

### 1. Field of the Invention

The present invention generally relates to an armoring layer for a communication cable. More particularly, the present invention relates to a welded, corrugated armoring layer.

### 2. Description of the Background

An armoring layer for a communication cable is well known in the art. An encircling armoring layer is made of a metal or alloy and is often corrugated for added strength. The armoring layer can provide crush resistance, rodent chew-though protection, cable cut resistance, shotgun blast resistance and water ingress protection for a communication cable. Such protections are needed for optical communication cables, which include one or more buffer tubes, each containing one or more optical fibers. A corrugated armoring layer can also act as a signal path for a toning signal to locate a buried cable and as a shield for electromagnetic interference (EMI). The shielding of EMI may be useful for some electrical cables and hybrid cables, which include both electrical and optical mediums.

FIG. 1 shows a fiber optic cable 8, having many buffer tubes 17 and/or filler rods 21 bundled together, as is known in the prior art. The fiber optic cable 8 has a six-around-one configuration, wherein six buffer tubes 17 and/or filler rods 21 are located around a central strength member 25. The central strength member 25 may be formed as a glass-reinforced plastic (GRP) rod or a fiber-reinforced plastic (FRP) rod. Alternatively, the cable core 15 may be made up of different numbers and types of cabling elements surrounding the central strength member 25, such as various combinations of buffer tubes 17, filler rods 21, twisted pairs of insulated conductors and insulated power conductors.

In FIG. 1, reference numeral 10 denotes an outer jacket. The outer jacket 10 surrounds a corrugated armoring layer 13, which surrounds a cable core 15 and has an overlapped portion 14. First and second binding threads or tapes 35 and 37 wrap around the cable core 15 to hold the core 15 together as the armoring layer 13 and jacket 10 are applied. Commonly, the first and second binding tapes 35 and 37 are made of flat, polyester tape.

FIG. 2 is a cross sectional view taken along line II-II in FIG. 1, with the cable core 15 removed. FIG. 2 illustrates a common issue at the overlapped portion 14 of the armoring layer 13. A first edge 3 of the armor layer 14 is tucked inside, i.e., on an inner side of the armoring layer 13, which faces the cable core 15. A second edge 5 extends past the first edge 3 a length L and overlies an outer side of the armoring layer 13, which faces the outer jacket 10. Ideally, the second edge 5 of the armoring layer 13 lies flat against the outer side of the armoring layer 13 and typically adhesives may be used to hold the second edge 5 to the outer side of the armoring layer 13 during the manufacturing of the cable 8. Unfortunately, at least along some intermittent portions of the length of the cable 8, the adhesive is ineffective or the second edge 5 did not fully engage to the outer side of the armoring layer and the second edge 5 tends to be slightly spaced away from the outer side of the armoring layer 13 at the overlapped portion 14 to create a gap G.

The second edge 5 is sharp and may tear the material of the outer jacket 10, especially when the cable 8 is being twisted, bent and/or pulled during an installation, e.g., pulled through a conduit bend or pulled over a guide during an aerial or drop installation. If the second edge 5 cuts through to the outer surface of the outer jacket 10, this is commonly referred to as a “zippering” of the outer jacket 10. A zippering of the outer jacket 10 can create an access point for water ingress into the cable 8.

### SUMMARY OF THE INVENTION

The applicant has appreciated drawbacks with the armoring layer 13 of the prior art and the manner by which the armoring layer 13 is overlapped back onto itself at the overlapped portion 14. It is an object of the present invention to address one or more of the appreciated drawbacks.

A basic disadvantage in the prior art is that the overlapped portion 14 adds cost, rigidity and weight to the overall cable 8. To reduce the cost, rigidity and weight, the overlapped portion 14 should be minimized and approach a length L of zero. However, a certain length of overlapped portion 14 is needed if the adhesive, such as a copolymer of ethylene acrylic acid (EAA), is used at the overlapped portion 14 to keep the second edge 5 in contact with the outer side of the armoring layer 13 and reduce the likelihood of zippering. When such an adhesive is used there is a need to extend the length L of the overlap 14 so that enough adhesive is present to connect the inner side of armoring layer 13 adjacent to the second edge 5 to the outer side of the armoring layer 13 adjacent to the first edge 3. Hence in accordance with the prior art, a compromise length L of the overlapped portion 14 must be established to serve both goals.

The applicant has also appreciated that the overlapped portion 14 of the armor layer 13 is a hindrance to any ripcord, like ripcords 7 and 9 in FIG. 1. The ripcords 7 or 9 are used to tear through the armoring layer 13 and will typically break when a technician attempts to pull the ripcord 7 or 9 through the overlapped portion 14 of the armoring layer 13. It is a goal to place the ripcords 7 and 9 in a distanced location relative to the overlapped portion 14 of the armoring layer 13. However, the ripcords 7 and 9 tend to move during the manufacturing of the cable 8 and can end up under or near the overlapped portion 14 of the armoring layer 13. Therefore, it would be beneficial to minimize the length L of the overlapped portion 14 of the armoring layer 13 from the perspective of accessing the cable core 15 using the ripcords 7 and 9.

To address these and other drawbacks, the present invention provides a new armoring layer and a new method of attaching the first and second end edges 3 and 5 of the armoring layer 13 so as to minimize or eliminate the overlapped portion 14 of the armoring layer 13. The principals of the present invention are particularly advantageous to the armor layer 13 formed of corrugated steel and used in conjunction with a fiber cable.

These and other objects are accomplished by a corrugated armoring layer for a communication cable, which is primarily formed of an elongated strip of metal or alloy, having a first side and an opposite, second side. The armoring layer is wrapped around a cable core so that first and second side edges come to abutment, or slightly overlap, and then are welded either continuously or intermittently to form a seam. In the preferred case of intermittent welding, only the tops or outward-facing ridges of the corrugations are welded, such as every top corrugation or every other top corrugation is welded. A conductive adhesive tape may be applied along the seam as well, if additional environmental sealing and/or electrical shielding is desired.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

For a better understanding of the invention, and to show how the same may be carried into effect, reference will now be made, by way of example, to the accompanying drawings, in which:

FIG. 1 is a perspective view of a fiber optic cable end with a portion of an outer jacket and an armoring layer removed to show the elements of the cable core, in accordance with the prior art;

FIG. 2 is a cross sectional view taken along line II-II in FIG. 1;

FIG. 3 is a perspective view of an end of a communication cable with a portion of an outer jacket removed to show an armoring layer in accordance with a first embodiment of the present invention;

FIG. 4 is a cross sectional view taken along line IV-IV in FIG. 3;

FIG. 5 is a perspective view of an end of a communication cable with a tape overlying a seam of the armoring layer;

FIG. 6 is a cross sectional view taken along line VI-VI in FIG. 5;

FIG. 7 is a perspective view of an end of a communication cable with a portion of an outer jacket removed to show an armoring layer in accordance with a second embodiment of the present invention; and

FIG. 8 is a perspective view of the end of the communication cable of FIG. 7 with a tape overlying a seam of the armoring layer.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

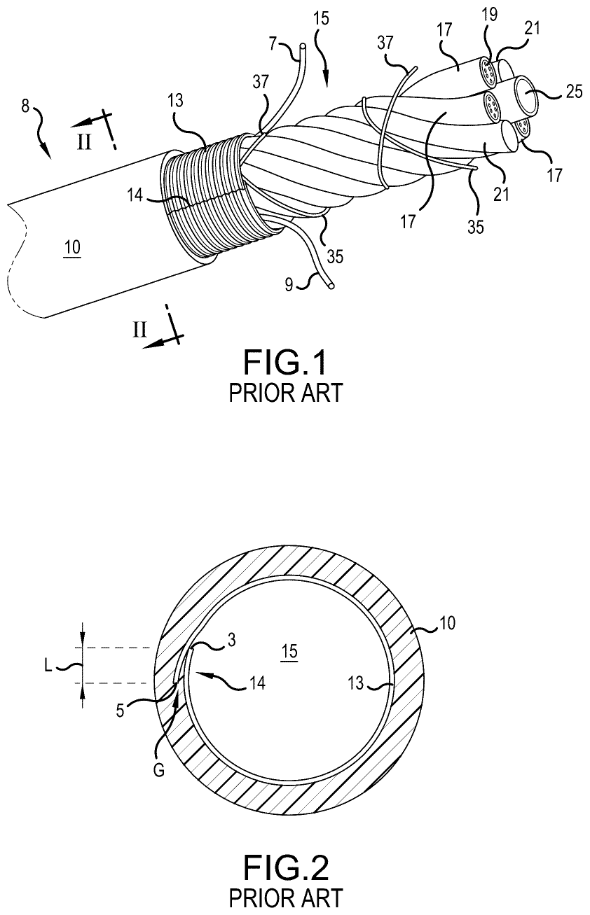

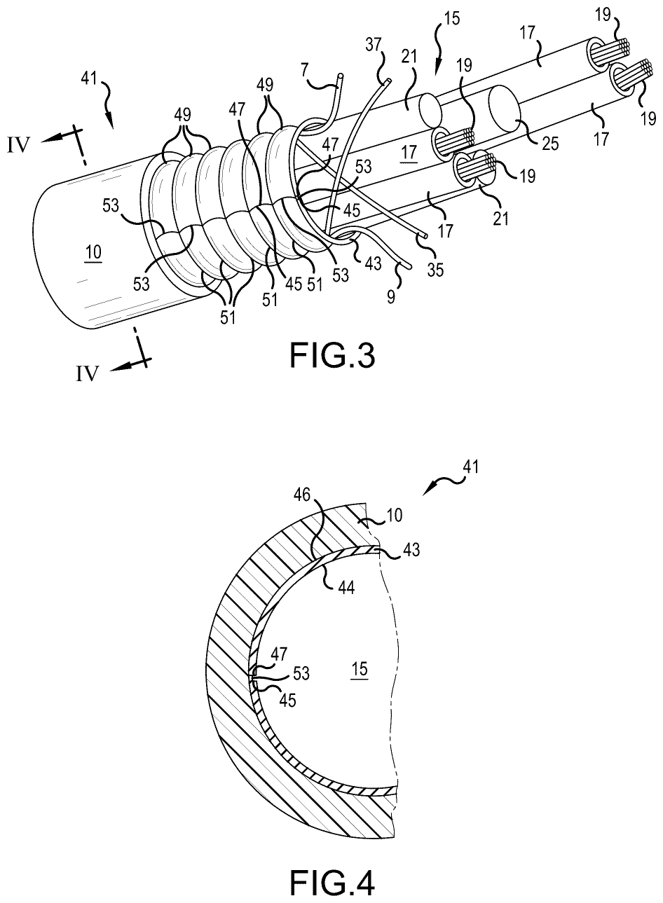

FIG. 3 is a perspective view of an end of a communication cable 41 with a portion of an outer jacket 10 removed to show a corrugated armoring layer 43 in accordance with a first embodiment of the present invention. FIG. 4 is a cross sectional view taken along line IV-IV in FIG. 3. The communication cable 41 may include a cable core 15 as shown in FIG. 1. For example, the cable core 15 may include four buffer tubes 17, each with at least one optical fiber, e.g., twelve optical fibers 19. The cable core 15 may also include one or more filler rods 21, e.g., two filler rods 21. The buffer tubes 17 and filler rods 21 surround a central strength member 25 and are bundled together by first and second binding threads or tapes 35 and 37 wrapped around the cable core 15. First and second ripcords 7 and 9 are adjacent to the cable core 15 and surrounded by the corrugated armoring layer 43. The outer jacket 10 surrounds a corrugated armoring layer 43.

The corrugated armoring layer 43 of the present invention differs from the armoring layer 13 of the prior art in FIG. 1. The corrugated armoring layer 43 may be formed as an elongated strip of a metal or alloy material, most preferably steel, such as electrolytically chrome-coated steel (ECCS), although aluminum or copper may be used in the embodiments of the present invention. The corrugated armoring layer 43 has a first or inner side 44 and an opposite, second or outer side 46, and a width defined between a first side edge 45 and a second side edge 47. The width is sufficient to wrap around the cable core 15, so that the first side edge 45 of the corrugated armoring layer 43 approximately abuts, e.g., contacts or nearly contacts, the second side edge 47 of the corrugated armoring layer 43. No overlapped portion 14, as shown in FIG. 1, exists.

The corrugated armoring layer 43 has annular ridges 49 which extend radially outward away from the cable core 15. The corrugated armoring layer 43 also has annular valleys 51 which extend radially inward toward the cable core 15. The annular ridges 49 and valleys 51 extend between the first and second side edges 45 and 47.

To hold the corrugated armoring layer 43 around the cable core 15 and form a seam, at least one weld 53 attaches the first side edge 45 and the second side edge 47 of the corrugated armoring layer 43 at the seam or the approximate abutment of the first and second side edges 45 and 47. In FIG. 3, a series of welds 53 are formed at the approximately abutting first and second side edges 45 and 47 at each of the peaks of the annular ridges 49. FIG. 3 illustrates a most preferred embodiment wherein the welds 53 only occur at the peaks of the annular ridges 49 and no welds 53 occur between the peaks of the annular ridges 49, e.g., in the valley 51 of the corrugated armoring layer 43.

The embodiment of FIG. 3 is most preferred because the forming of the welds 53 may be performed after the corrugation of the corrugated armoring layer 43, as the cable is being produced at line speed, e.g., approximately 100 meters per minute. A welding tip producing the welds 53 can remain at a set distance from the cable moving at line speed to place welds 53 only at the peaks of the abutted, or nearly abutted, annular ridges 49 of the first and second side edges 45 and 47. Such intermittent welds 53 are sufficient to hold the corrugated armoring layer 43 around the cable core 15 during the jacketing process when the outer jacket 10 is extruded over the corrugated armoring layer 43.

One alternative to the present invention may be to only place welds 53 at some of the peaks of the abutted, or nearly abutted, annular ridges 49 of the first and second side edges 45 and 47. For example, every other annular ridge 49 may have a weld 53, or every third annular ridge 49 may have a weld 53. Such a process would be accomplished by a timing trigger system which is tied to a camera or sensor sensing the passing annular ridges 49 and only triggers the welding tip to produce welds in a sequence or series which purposefully skips some annular ridges 49. This process may reduce the expense of the material to the form the welds 53 and may still yield an attachment pattern of intermittent welds 53 which are sufficient to hold the corrugated armoring layer 43 around the cable core 15 during the jacketing process when the outer jacket 10 is extruded over the corrugated armoring layer 43.

Another alternative would be to produce a continuous weld 53 between the abutted, or nearly abutted, annular ridges 49 of the first and second side edges 45 and 47 while the armoring layer is flat, i.e., prior to the corrugation process. The corrugated armoring layer 43 would be formed by corrugating the continuous weld 53 along with the steel forming the “flat” armoring layer. This alternative would use much more material to form the weld 53, but would produce a more sealed corrugated armoring layer 43, which would be an improvement to prevent water ingress in the case of a tear in the outer jacket 10. Further, the corrugated armoring layer 43 could serve as a shielding layer if the cable core 15 included electrical conductors and EMI was an issue to be addressed.

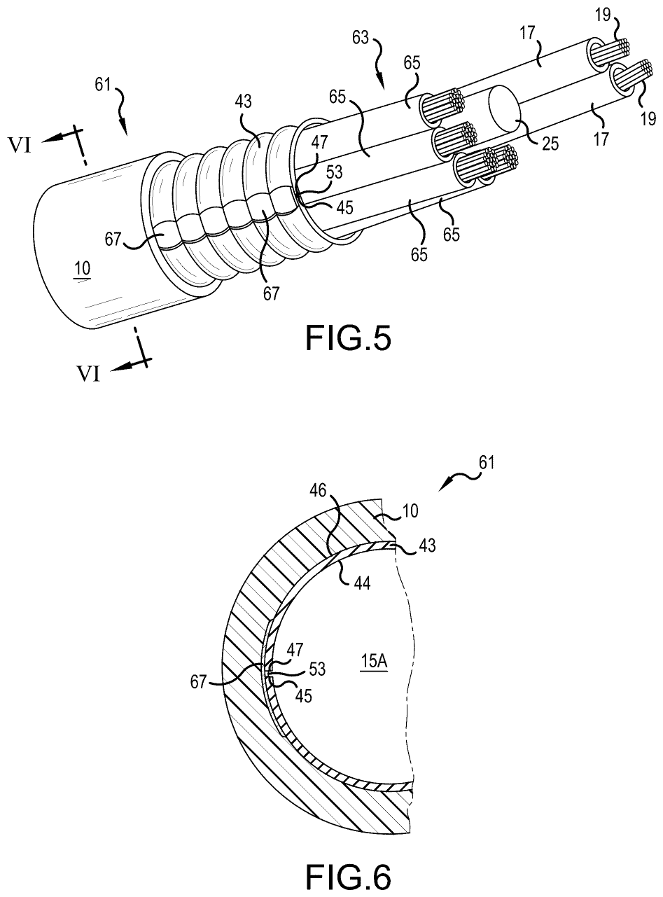

FIG. 5 shows a perspective view of an end of a communication cable 61. FIG. 6 is a cross sectional view taken along line VI-VI in FIG. 5. The communication cable 61 is similar to the communication cable 41 of FIGS. 3 and 4, however the cable core 15 of FIGS. 3 and 4 has been replaced with a cable core 63, and the seam between the first and second side edges 45 and 47 has been covered, as will be further explained.

The cable core 63 includes the central strength member 25 and two buffer tubes 17, each containing at least one optical fiber 19. However, the other two buffer tubes 17 and two filler rods 21 of FIG. 3 have been replaced with insulated conductors 65. The insulated conductors 65 may be used for power transmission and/or communication signals. Since the cable core 63 includes insulated electrical conductors 65, EMI entering or exiting the cable 61 may be an issue to be addressed and EMI shielding may be desired.

In FIGS. 5 and 6, the corrugated armoring layer 43 is formed identically to the corrugated armoring layer 43 depicted in FIGS. 3 and 4. Hence, only the peaks of the abutted, or nearly abutted, annular ridges 49 of the first and second side edges 45 and 47 have welds 53. For example, all of the peaks of the annular ridges 49 or a series of the peaks of the annular ridges 49, e.g., every third peak, may have a weld 53. The remaining portions of the approximate abutment or seam between the first and second side edges 45 and 47 do not include a weld 53.

As shown in FIGS. 5 and 6, a tape 67 is adhered over the seam between the first and second side edges 45 and 47. More specifically, the tape 67 may be adhered to the second side 46 of the corrugated armoring layer 43 proximate the second side edge 47, across the second side edge 47 in approximate abutment with the first side edge 45, and adhered to the second outer side 46 of the corrugated armoring layer 43 proximate the first side edge 45. The tape 67 may optionally have conductive properties, such as a tri-laminated tape with an adhesive, a conductive foil and an outer structurally strong polymer. The conductive foil may be electrically connected to the second side 46 of the corrugated armoring layer 43 on opposite sides of the seam between the approximately abutted first and second side edges 45 and 47 and may act to environmentally seal and electrically shield the cable core 63 and prevent EMI from passing through the seam where welds 53 are not present.

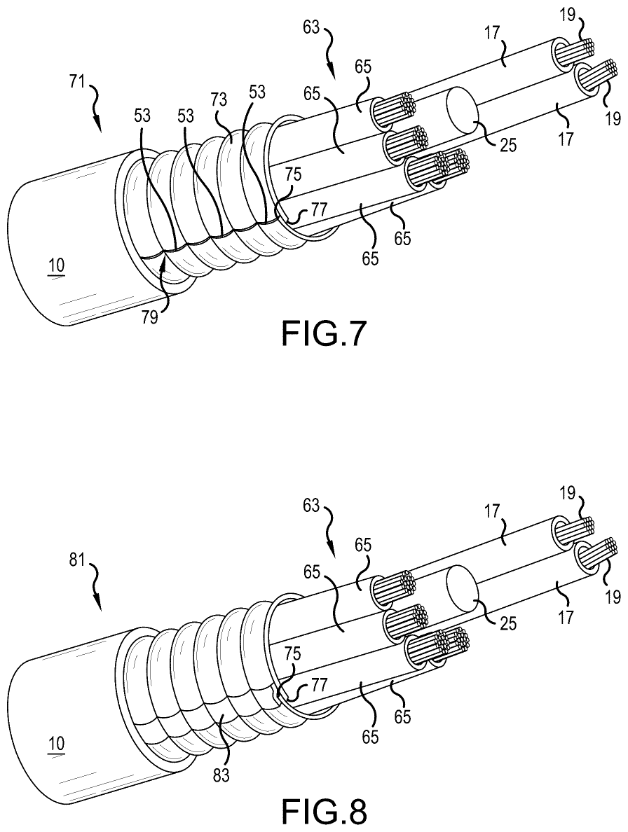

FIG. 7 is a perspective view of an end of a communication cable with a portion of an outer jacket 10 removed to show a corrugated armoring layer 73 in accordance with a second embodiment of the present invention. The cable core 63 may be formed the same as in FIG. 5, however the corrugated armoring layer 73 is different from the corrugated armoring layer 43 of FIGS. 3-6 as will be further explained.

To this end, a width of the corrugated armoring layer 73 between a first side edge 75 and a second side edge 77 is wider than a width of the armoring layer 43 between the first side edge 45 and the second side edge 47. The width of the corrugated armoring layer 73 is sufficient to wrap around the cable core 63 and overlap back onto itself to form an overlapped portion 79. As shown in FIG. 7, the first side edge 75 overlaps the second side edge 77, however the opposite arrangement is also possible. The corrugated armoring layer 73 is preferably formed of steel and corrugated to have annular ridges and valleys extending between the first and second side edges 75 and 77, as previously described in relation to FIGS. 3 and 5.

In a preferred embodiment, the overlapped portion 79 is shorter than the overlapped portion 14 of the prior art depicted in FIGS. 1 and 2. This allows for a reduction in costs, materials and weight of the cable, as well as a reduced likelihood that a ripcord will be broken trying to pull through the overlapped portion 79. The overlapped portion 79 may be made smaller because an adhesive like EAA is not used to attach the inner side 44 of the corrugated armoring layer 73 proximate the first side edge 75 to the outer side 46 of the corrugated armoring layer 73 proximate the second side edge 77. Most armoring layers are provided to the cable manufacturer with EAA and a coating over the EAA already residing on the entirety of the first and/or second sides 44 and/or 46 of the armoring layer. Hence, a plain “uncoated” metal strip, without EAA, may be used in the present invention, and such an “uncoated” metal strip will be less expensive.

Instead of an adhesive, at least one weld 53 is formed between the first side edge 75 and the second side 46 of the corrugated armoring layer 73 proximate the second side edge 77. FIG. 7 depicts welds 53 formed at alternating peaks of the ridges of the corrugated armoring layer 73, i.e., every other peak is welded and the peaks between are not welded. Other patterns are also possible, such as every third peak of a ridge is attached by a weld 53, and also an alternative where all peaks of the ridges are attached by a weld 53. Also, the weld 53 may be a continuous weld formed at all portions of first side edge 75 in contact with the second side 46 of the corrugated armoring layer 73.

Since the cable core 63 includes insulated electrical conductors 65, EMI entering or exiting the cable 71 may be an issue to be addressed and EMI shielding may be desired. The overlapped portion 79 will provide good EMI shielding as the cable core 63 is completely surrounded by the corrugated armoring layer 73. However, if additional EMI shielding is desired, and/or if additional environmental sealing of the seam between the first side edge 75 and the second side 46 of the corrugated armoring layer 73 is needed, FIG. 8 shows a modification which may optionally be used.

In the modification of FIG. 8, a tape 83 is adhered to the second side 46 of the armoring layer 73 proximate said first side edge 75, across the first side edge 75, and adhered to the second side 46 of the corrugated armoring layer 73 proximate said second side edge 77. The tape 83 may optionally have conductive properties, such as a tri-laminated tape with an adhesive, a conductive foil and an outer structurally strong polymer. The conductive foil may be electrically connected to the second side 46 of the corrugated armoring layer 73 on opposite sides of the seam between the first side edge 55 and the second side 46 of the corrugated armoring layer 73. The tape 83 may act to environmentally seal and electrically shield the cable core 63 and prevent EMI from passing through the seam where welds 53 are not present.

A general method of making a communication cable 41, 61, 71 and 81 in accordance with the present invention includes the steps of paying an elongated strip of material, having a first exposed side and an opposite, second exposed side, and a width defined between a first side edge and a second side edge, into a cable forming machine. In the cable forming machine, the method includes engaging a cable core against the first exposed side of the elongated strip of material, between the first and second sides edges. Then, the method includes bringing at least one of the first and second side edges of the elongate strip of material around the cable core. Welding is used to attach the first side edge to a portion of the elongated strip of material at or proximate the second side edge. A corrugated armoring layer is formed by corrugating the elongated strip of material, forming annular ridges and valleys extending between the first and second side edges. Finally, the cable forming machine performs the step of extruding a jacket over the corrugated armoring layer.

In a preferred embodiment, the corrugating operation on the elongated strip of material occurs prior to welding the first side edge to a portion of the elongated strip of material at or proximate the second side edge. Also, in a more preferred embodiment, bringing at least one of the first and second side edges of the elongate strip of material around the cable core includes approximately abutting the first side edge to the second side edge, and the welding process is a series of welds occurring only at ridges of corrugation of the first side edge which are approximately abutted with ridges of corrugation of the second side edge of the armoring layer.

Optionally, an environmentally sealing and/or EMI shielding tape may be used to cover a seam where the first side edge is attached to the second side edge or second side of the armoring layer. If the tape is provided, the method of manufacturing may include adhering the tape to the second side of the armoring layer proximate the first side edge, across the first side edge in abutment with, or overlapping the second side edge, and then adhering the tape to the second side of the armoring layer proximate the second side edge.

Although certain cable cores 15 and 63 have been illustrated in the drawings, alternative cable cores with greater or fewer cable elements may be used in conjunction with the corrugated armoring layers 43 and 73 of the present invention. For example, the cable cores 15 and 63 may be made up of different numbers and types of cabling elements surrounding the central strength member 25, such as various combinations of buffer tubes 17, filler rods 21, twisted pairs of insulated conductors and insulated power conductors.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

We claim:

1. A communication cable comprising:
a cable core including one or more buffer tubes, each containing one or more optical fibers;
an armoring layer surrounding said cable core, wherein said armoring layer is formed as an elongated strip of a metal or alloy material having a first side and an opposite, second side, and a width defined between a first side edge and a second side edge, wherein said width is sufficient to wrap around a cable core and contact said first side edge to said second side edge to form an approximate abutment when said armoring layer surrounds said cable core, wherein said armoring layer is corrugated to have annular ridges and valleys extending between said first and second side edges; and
at least one weld formed between said first side edge and said second side edge of said armoring layer at said abutment.

2. The communication cable according to claim 1, wherein said at least one weld is a continuous weld formed along said abutment of said first side edge to said second side edge of said armoring layer.

3. The communication cable according to claim 2, further comprising:
a tape adhered to said second side of said armoring layer proximate said first side edge, across said abutment of said first side edge to said second side edge, and adhered to said second side of said armoring layer proximate said second side edge.

4. The communication cable according to claim 1, wherein said at least one weld is a series of welds which occur only at ridges of corrugation of said first side edge which are in approximate abutment with ridges of corrugation of said second side edge of said armoring layer.

5. The communication cable according to claim 4, wherein said series of welds occur at all ridges of corrugation of said first side edge which are in approximate abutment with all ridges of corrugation of said second side edge of said armoring layer.

6. The communication cable according to claim 4, wherein said series of welds occur at alternating ridges of corrugation of said first side edge which are in approximate abutment with alternating ridges of corrugation of said second side edge of said armoring layer.

7. The communication cable according to claim 4, further comprising:
a tape adhered to said second side of said armoring layer proximate said first side edge, across said first side edge in approximate abutment with said second side edge, and adhered to said second side of said armoring layer proximate said second side edge.

8. The communication cable according to claim 1, wherein said metal or alloy material is steel, aluminum or copper.

9. A communication cable comprising:
a cable core including one or more buffer tubes, each containing one or more optical fibers;
an armoring layer surrounding said cable core, wherein said armoring layer is formed as an elongated strip of a metal or alloy material having a first side and an opposite, second side, and a width defined between a first side edge and a second side edge, wherein said width is sufficient to wrap around a cable core and overlap back onto itself when said armoring layer surrounds said cable core so as to form an overlapped portion, wherein said armoring layer is corrugated to have annular ridges and valleys extending between said first and second side edges; and
at least one weld formed between said first side edge and said second side of said armoring layer proximate said second side edge.

10. The communication cable according to claim 9, wherein said at least one weld is a continuous weld formed at all portions of first side edge in contact with said second side of said armoring layer.

11. The communication cable according to claim 10, further comprising:
a tape adhered to said second side of said armoring layer proximate said first side edge, across said first side edge, and adhered to said second side of said armoring layer proximate said second side edge.

12. The communication cable according to claim 9, wherein said at least one weld is a series of welds which occur only at ridges of corrugation of said first side edge which are in contact with ridges of corrugation of said second side of said armoring layer.

13. The communication cable according to claim 12, wherein said series of welds occur at all ridges of corrugation of said first side edge which are in contact with all ridges of corrugation of said second side of said armoring layer.

14. The communication cable according to claim 12, wherein said series of welds occur at alternating ridges of corrugation of said first side edge which are in contact with alternating ridges of corrugation of said second side of said armoring layer.

15. The communication cable according to claim 12, further comprising:
a tape adhered to said second side of said armoring layer proximate said first side edge, across said first side edge, and adhered to said second side of said armoring layer proximate said second side edge.

16. The communication cable according to claim 9, wherein said metal or alloy material is steel, aluminum or copper.

17. A method of making a communication cable comprising:
paying an elongated strip of material, having a first exposed side and an opposite, second exposed side, and a width defined between a first side edge and a second side edge, into a cable forming machine;
engaging a cable core against the first exposed side of the elongated strip of material, between the first and second sides edges;
bringing at least one of the first and second side edges of the elongate strip of material around the cable core;
welding the first side edge to a portion of the elongated strip of material at or proximate the second side edge;
corrugating the elongated strip of material forming annular ridges and valleys extending between the first and second side edges to form a corrugated armoring layer; and
extruding a jacket over the corrugated armoring layer.

18. The method according to claim 17, wherein said corrugating the elongated strip of material occurs prior to said welding the first side edge to a portion of the elongated strip of material at or proximate the second side edge.

19. The method according to claim 18, wherein said bringing at least one of the first and second side edges of the elongate strip of material around the cable core includes approximately abutting the first side edge to the second side edge, and wherein said welding is a series of welds which occur only at ridges of corrugation of the first side edge which are in approximate abutment with ridges of corrugation of the second side edge of the armoring layer.

20. The method according to claim 19, further comprising:
adhering a tape to the second side of the armoring layer proximate the first side edge, across the first side edge in approximate abutment with the second side edge, and then adhering the tape to the second side of the armoring layer proximate the second side edge.
